(19) United States
(12) Patent Application Publication
(10) Pub. No.: US 2026/0067671 A1
(43) Pub. Date: Mar. 5, 2026

(54) SIGNALING FOR ADAPTING UE CONFIGURATION TO THE CELL LOAD

(71) Applicant: Fraunhofer-Gesellschaft zur Förderung der angewandten Forschung e.V., Munchen (DE)

(72) Inventors: Gustavo Wagner OLIVEIRA DA COSTA, Erlangen (DE); Geordie GEORGE, Erlangen, DE (US); Nazanin VATANIAN, Erlangen (DE); Elke ROTH-MANDUTZ, Erlangen (DE)

(21) Appl. No.: 19/300,328

(22) Filed: Aug. 14, 2025

Related U.S. Application Data
(63) Continuation of application No. PCT/EP2024/053706, filed on Feb. 14, 2024.

(30) Foreign Application Priority Data
Feb. 15, 2023 (EP) 23156827.0

(51) Int. Cl. H04W 8/22; H04W 52/02

(52) U.S. Cl. CPC H04W 8/22; H04W 52/0209

(57) ABSTRACT

Embodiments provide a user equipment, UE, of a wireless communication network [e.g., 5G/NR], wherein the user equipment is configured to operate [e.g., to transmit and/or receive signals] using a baseline configuration, wherein the user equipment is configured to receive a control signal from a base station [e.g., eNB] of the wireless communication network, wherein the user equipment is configured to activate or deactivate, in dependence on the received control signal, a further configuration [e.g., load-adapted or load-specific configuration] [e.g., one out of at least two different further configurations].

### CROSS-REFERENCES TO RELATED APPLICATIONS

This application is a continuation of copending International Application No. PCT/EP2024/053706, filed Feb. 14, 2024, which is incorporated herein by reference in its entirety, and additionally claims priority from European Application No. EP 23 156 827.0, filed Feb. 15, 2023, which is incorporated herein by reference in its entirety.

Embodiments of the present application relate to the field of wireless communication, and more specifically, to adapting UE configuration to follow a load of the wireless communication system. Some embodiments relate to network energy saving related configurations. Some embodiments relate to Cell DTX and DRX.

### BACKGROUND OF THE INVENTION

FIG. 1 is a schematic representation of an example of a terrestrial wireless network 100 including, as is shown in FIG. 1 (a), a core network 102 and one or more radio access networks (RANs) RAN1, RAN2, . . . RANN. FIG. 1 (b) is a schematic representation of an example of a radio access network RANn that may include one or more base stations (BSs) gNB1 to gNB5, each serving a specific area surrounding the base station schematically represented by respective cells 1061 to 1065. The base stations are provided to serve users within a cell. The term base station, BS, refers to a next generation node B (gNB) in 5G networks, an evolved node B (eNB) in UMTS/LTE/LTE-A/LTE-A Pro, or just a BS in other mobile communication standards. A user may be a stationary device or a mobile device. The wireless communication system may also be accessed by mobile or stationary Internet of Things (IoT) devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1 (b) shows an exemplary view of five cells, however, the RANn may include more or less such cells, and RANn may also include only one base station. FIG. 1 (b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1 (b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1 (b) by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1 (b) by the arrows pointing to “gNBs”.

For data transmission a physical resource grid may be used. The physical resource grid may comprise a set of resource elements (REs) to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 orthogonal frequency-division multiplexing (OFDM) symbols depending on the cyclic prefix (CP) length. All OFDM symbols may be used for downlink (DL) or uplink (UL) or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the OFDM system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in a radio resource control (RRC) connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex (TDD) systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a wireless communication system as described above, on the UE side, the application of Discontinuous Reception (DRX) is common place in order to reduce the power consumption. The technique name points to turning off the UE reception.

The energy consumption on the network side is also being of increasing attention due to environmental and economic considerations.

On the UE side, there are actually two types of DRX depending on the RRC state of the UE:
connected mode DRX, also known as C-DRX, and
idle/inactive DRX.

In idle/inactive DRX the UE wakes periodically to check for paging messages. In C-DRX, the UE wakes up periodically to check for PDCCH messages, which may signal whether data will be transmitted to the UE or not.

Subsequently, a short description of C-DRX is provided, as C-DRX may be aligned with Cell DTX mechanism (e.g., the gNB stops transmissions when the UE stops receiving).

C-DRX is mainly described in [2], and in further detail in [3] and [4]. In essence, the UE configured for C-DRX will follow cycles, namely DRX cycles with ON and OFF periods. ON and OFF in this sense is mainly understood as PDCCH reception ON and PDCCH reception OFF. Thus, PDSCH scheduling and therefore data reception can only start on ON periods, while the UE can turn off many components during the OFF time. This cycle operation will apply for as long as the UE does not receive any traffic. Actually, if the UE continuously receive traffic it will also be actively receiving PDCCH continuously. In order to control how long a UE stays awake after being scheduled in PDCCH, there is a DRX inactivity timer. Basically, every time a PDCCH is received this timer is reset. If the timer reaches zero (without any PDCCH reception), the UE will enter DRX OFF state.

In addition to the regular C-DRX cycle, named on the specs as long DRX cycle, there is the possibility of configuring a short DRX cycle. Having two different cycles (long and short) is beneficial for certain types of traffic. For example, VoIP traffic can benefit from long-DRX in periods without voice activity (e.g., where SID (Silence Insertion Descriptor) frames are sparsely sent, e.g., every 160 ms) and short-DRX matching the voice frames periodicity (e.g., 20 ms) during voice activity.

Further considerations on C-DRX are when retransmissions are expected and the possibility of setting a second DRX group intended for cases when the UE is connected to different cell groups.

During DRX the UE can still transmit in uplink, for example, on PRACH, PUCCH, sending a SR (scheduling request) or using an uplink CG-PUSCH (Configured Grant PUSCH). In short, basically the UE will only be totally off during C-DRX if it has no data to transmit. If it has data to transmit the UE can transmit to the network on pre-configured resources or trigger a new resource allocation.

The main reference for Cell DTX and Cell DRX is [5]. A general description of Cell DTX and Cell DRX can be found in section 6.1.4 of [5]. The description in [5] is still at a high level and therefore it does not represent a complete and practical solution which can be implemented.

One important consideration of Cell DTX mentioned in [5] is to align the periods which the gNB does not transmit (Cell DTX) with the periods at which UEs do not receive (C-DRX). Aligning the periods of different UEs can be already done via gNB implementation, but only RRC signaling can be used and such signaling needs to be done to all UEs individually, one by one.

In addition to that, several references in literature propose to use duty cycles of transmission or reception from base stations in order to save energy. Although, such duty cycles are conceptually simple they are hard to implement as real systems have a great number of other practical considerations.

Therefore, there is the need for improvements or enhancements with respect to energy savings on the network side.

It is noted that the information in the above section is only for enhancing the understanding of the background of the invention and therefore it may contain information that does not form conventional technology and is already known to a person of ordinary skill in the art.

### SUMMARY

An embodiment may have a user equipment, UE, of a wireless communication network, wherein the user equipment is configured to operate using a baseline configuration, wherein the user equipment is configured to receive a control signal from a base station of the wireless communication network, wherein the user equipment is configured to activate or deactivate, in dependence on the received control signal, a further configuration, wherein the baseline configuration defines a plurality of operating parameters of the user equipment, wherein the further configuration is configured to, when activated,
add at least one operating parameter to the baseline configuration, and/or
remove at least one operating parameter from the baseline configuration.

Another embodiment may have a user equipment UE, of a wireless communication network, wherein the user equipment is configured to operate using a baseline configuration, wherein the user equipment is configured to receive a control signal from a base station of the wireless communication network, wherein the user equipment is configured to activate or deactivate, in dependence on the received control signal, a further configuration, wherein the further configuration defines that cell DTX is activated and that one or more parameters of connected mode DRX parameters are modified, wherein the user equipment is configured, if the cell DTX cycle is a multiple of the connected mode DRX cycle or the connected mode DRX cycle is a multiple of the cell DTX cycle, to select the largest of the two cycles, or wherein the user equipment is configured, if the cell DTX cycle is not a multiple of the connected mode DRX cycle or the connected mode DRX cycle is not a multiple of the cell DTX cycle, to apply the cell DTX cycle when cell DTX is active.

Another embodiment may have a base station of a wireless communication network, wherein the base station is configured to transmit a control signal to a user equipment of the wireless communication network, wherein the control signal is configured to control the user equipment to activate or deactivate a further configuration, wherein the baseline configuration defines a plurality of operating parameters of the user equipment, wherein the further configuration is configured to, when activated,
add at least one operating parameter to the baseline configuration, and/or
remove at least one operating parameter from the baseline configuration.

Another embodiment may have a base station of a wireless communication network, wherein the base station is configured to transmit a control signal to a user equipment of the wireless communication network, wherein the control signal is configured to control the user equipment to activate or deactivate a further configuration wherein the further configuration defines that cell DTX is activated and that one or more parameters of connected-mode DRX parameters of the user equipment are modified, wherein, if the cell DTX cycle is a multiple of the connected mode DRX cycle or the connected mode DRX cycle is a multiple of the cell DTX cycle, the largest of the two cycles is selected, or wherein, if the cell DTX cycle is not a multiple of the connected mode DRX cycle or the connected mode DRX cycle is not a multiple of the cell DTX cycle, the cell DTX cycle is applied when cell DTX is active, wherein the base station is configured to transmit the control signal comprising a control information, wherein the control information signals whether the further configuration is to be activated or deactivated or which further configuration out of a plurality of different further configurations is to be activated or deactivated, wherein the further configuration is a network energy saving configuration in which the base station operates in a connected-mode discontinuous reception, connected-mode DRX, mode of operation, wherein the base station is configured to transmit the control signal comprising the control information only in on-durations of the connected-mode discontinuous reception, connected-mode DRX, mode of operation or with a defined time offset to the on-durations of the connected-mode discontinuous reception, connected-mode DRX, mode of operation or only in active durations of the connected-mode discontinuous reception, connected-mode DRX, mode of operation.

Another embodiment may have a method for operating a user equipment of a wireless communication network, the method comprising: operating the user equipment using a baseline configuration, receiving a control signal from a base station of the wireless communication network, activating or deactivating, in dependence on the received control signal, a further configuration, wherein the baseline configuration defines a plurality of operating parameters of the user equipment, wherein the further configuration is configured to, when activated,
add at least one operating parameter to the baseline configuration, and/or
remove at least one operating parameter from the baseline configuration.

Another embodiment may have a method for operating a user equipment of a wireless communication network, the method comprising: operating the user equipment using a baseline configuration, receiving a control signal from a base station of the wireless communication network, activating or deactivating, in dependence on the received control signal, a further configuration, wherein the further configuration defines that cell DTX is activated and that one or more parameters of connected mode DRX parameters are modified, wherein the user equipment is configured, if the cell DTX cycle is a multiple of the connected mode DRX cycle or the connected mode DRX cycle is a multiple of the cell DTX cycle, to select the largest of the two cycles, or wherein the user equipment is configured, if the cell DTX cycle is not a multiple of the connected mode DRX cycle or the connected mode DRX cycle is not a multiple of the cell DTX cycle, to apply the cell DTX cycle when cell DTX is active.

Another embodiment may have a method for operating a base station of a wireless communication network, the method comprising: transmitting a control signal to a user equipment of the wireless communication network, wherein the control signal is configured to control the user equipment to activate or deactivate a further configuration, wherein the baseline configuration defines a plurality of operating parameters of the user equipment, wherein the further configuration is configured to, when activated,
add at least one operating parameter to the baseline configuration, and/or
remove at least one operating parameter from the baseline configuration.

Another embodiment may have a method for operating a base station of a wireless communication network, the method comprising: transmitting a control signal to a user equipment of the wireless communication network, wherein the control signal is configured to control the user equipment to activate or deactivate a further configuration, wherein the further configuration defines that cell DTX is activated and that one or more parameters of connected-mode DRX parameters of the user equipment are modified, wherein, if the cell DTX cycle is a multiple of the connected mode DRX cycle or the connected mode DRX cycle is a multiple of the cell DTX cycle, the largest of the two cycles is selected, or wherein, if the cell DTX cycle is not a multiple of the connected mode DRX cycle or the connected mode DRX cycle is not a multiple of the cell DTX cycle, the cell DTX cycle is applied when cell DTX is active, wherein the control signal comprises a control information, wherein the control information signals whether the further configuration is to be activated or deactivated or which further configuration out of a plurality of different further configurations is to be activated or deactivated, wherein the further configuration is a network energy saving configuration in which the base station operates in a connected-mode discontinuous reception, connected-mode DRX, mode of operation, wherein the control signal comprising the control information is transmitted only in on-durations of the connected-mode discontinuous reception, connected-mode DRX, mode of operation or with a defined time offset to the on-durations of the connected-mode discontinuous reception, connected-mode DRX, mode of operation or only in active durations of the connected-mode discontinuous reception, connected-mode DRX, mode of operation.

Another embodiment may have a non-transitory digital storage medium having a computer program stored thereon to perform the method for operating a user equipment of a wireless communication network, the method comprising: operating the user equipment using a baseline configuration, receiving a control signal from a base station of the wireless communication network, activating or deactivating, in dependence on the received control signal, a further configuration, wherein the baseline configuration defines a plurality of operating parameters of the user equipment, wherein the further configuration is configured to, when activated, add at least one operating parameter to the baseline configuration, and/or remove at least one operating parameter from the baseline configuration, when said computer program is run by a computer.

### BRIEF DESCRIPTION OF THE DRAWINGS

Embodiments of the present invention will be detailed subsequently referring to the appended drawings, in which:

FIG. 1 shows a schematic representation of an example of a wireless communication system;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7a shows a schematic representation of configurations based on which a UE can be configured to operate, where the configurations include a baseline configuration and a plurality of further configurations, such as Cell DTX configurations, according to an embodiment;

FIG. 7b shows a schematic representation of configurations based on which a UE can be configured to operate, where the configurations include a baseline configuration and a plurality of further configurations, such as Cell DRX configurations, according to an embodiment;

FIG. 8 shows a schematic representation of configurations based on which a UE can be configured to operate, where the configurations include a baseline configuration and a plurality of further configurations, such as NES configurations, according to an embodiment;

FIG. 9a shows a schematic representation of configurations based on which a UE can be configured to operate, where the configurations include a baseline configuration A and a further configuration, such as a NES configuration A, according to an embodiment;

FIG. 9b shows a schematic representation of configurations based on which a UE can be configured to operate, where the configurations include a baseline configuration B and a further configuration, such as a NES configuration B, according to an embodiment;

FIG. 9c shows a schematic representation of configurations based on which a UE can be configured to operate, where the configurations include a baseline configuration C and two further configurations, such as a NES configuration C1 and NES configuration C2, according to an embodiment;

FIG. 10 shows a schematic representation of two different configurations based on which a UE can operate, where the different configurations include a baseline configuration in which CD-SSBs are transmitted periodically and a further configuration which adds NCD-SSB transmissions having an independent timing in between the CD-SSB transmissions, according to an embodiment;

FIG. 11 shows a schematic representation of two different configurations based on which a UE can operate, where the different configurations include a baseline configuration in which CD-SSBs are transmitted periodically and a further configuration which adds NCD-SSB transmissions having a dependent timing in between the CD-SSB transmissions, according to an embodiment; and

FIG. 12 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

Embodiments described herein enable wireless network infrastructure nodes (e.g., gNBs) to save energy by dynamically changing configuration. One exemplary application is to create instants of time where the gNB can turn off circuitry, in either DRX and/or DTX.

Embodiments provide a concept for applying Cell DTX and Cell DRX in 5G NR and future standards.

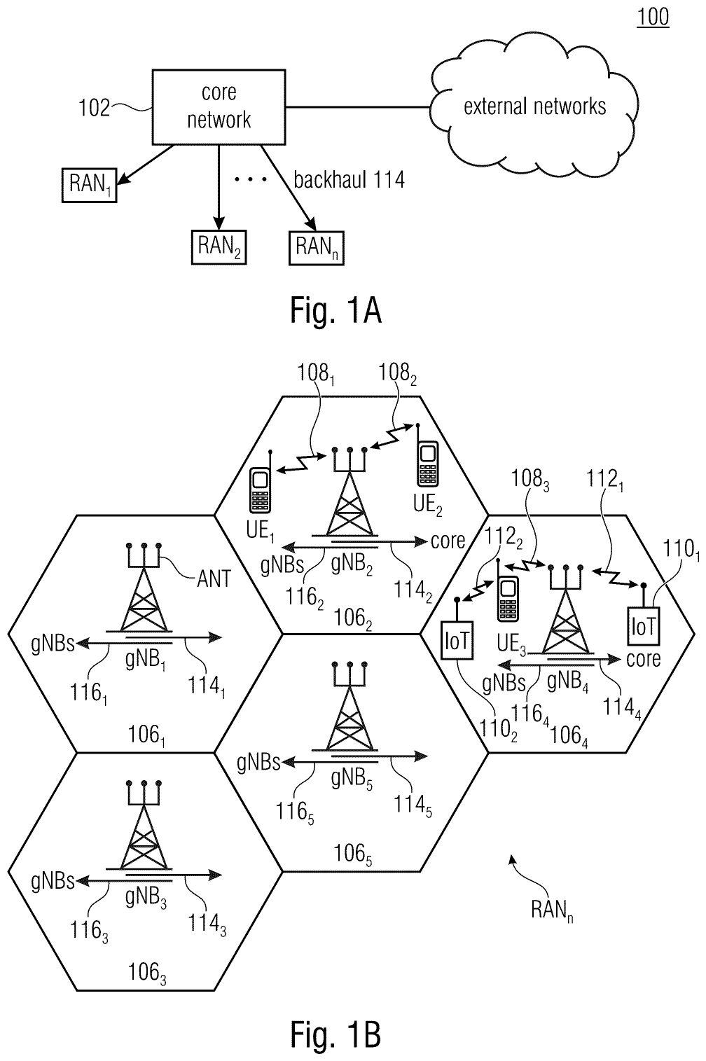

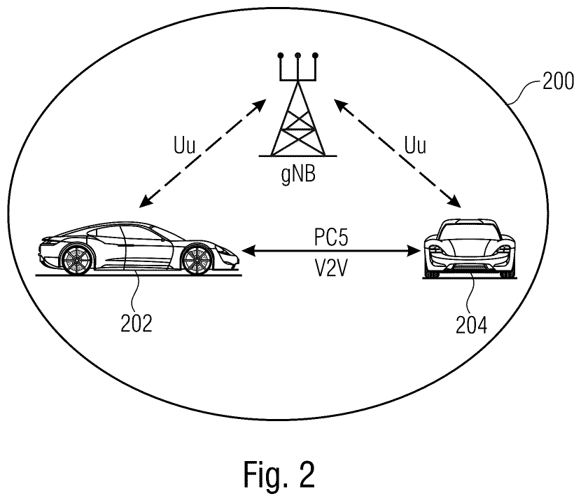

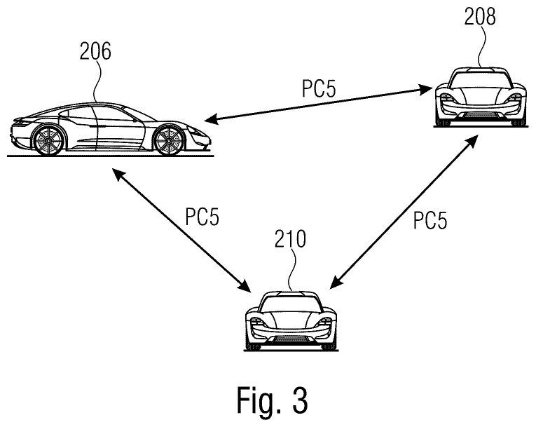

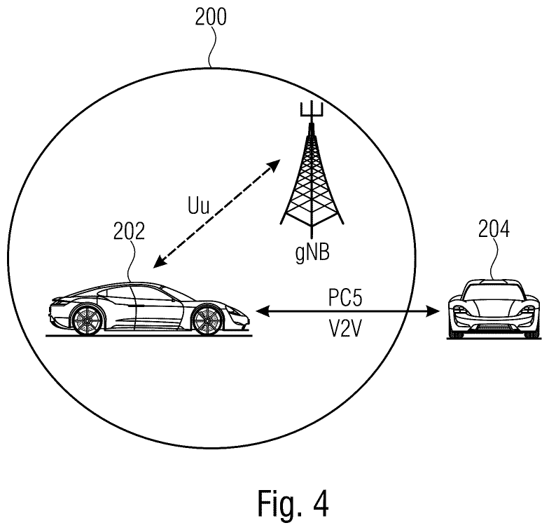

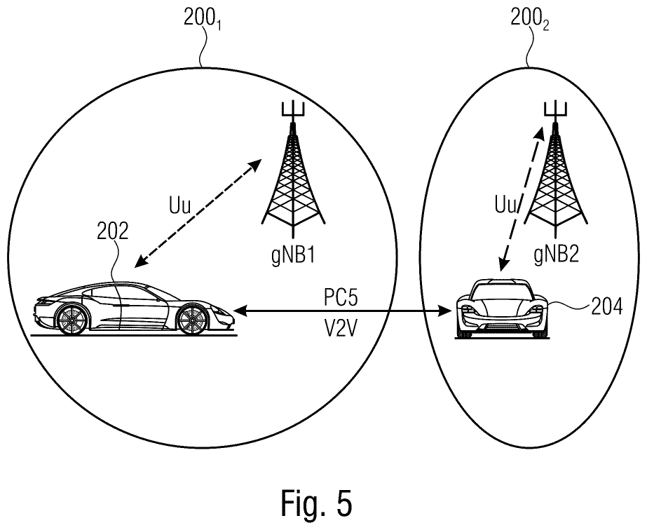

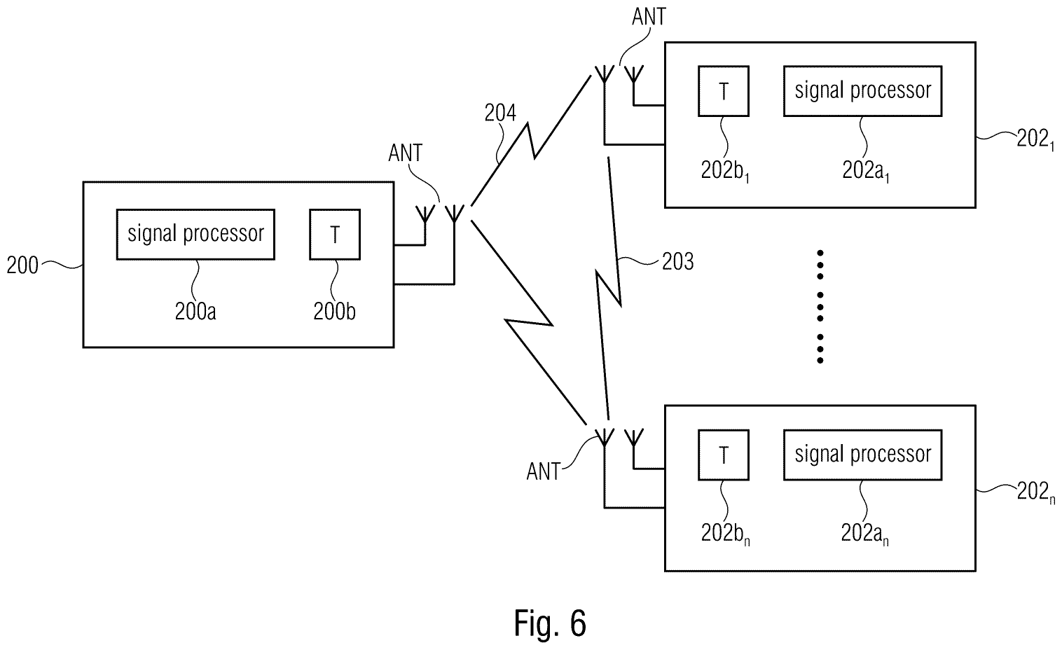

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station, and a plurality of communication devices 2021 to 202n, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a1 to 202an, and a transceiver (e.g., receiver and/or transmitter) unit 202b1 to 202bn. The base station 200 and/or the one or more UEs 202 may operate in accordance with the inventive teachings described herein.

Embodiments provide an user equipment, UE, of a wireless communication network [e.g., 5G/NR], wherein the user equipment is configured to operate [e.g., to transmit and/or receive signals] using a baseline configuration, wherein the user equipment is configured to receive a control signal from a base station [e.g., eNB] of the wireless communication network, wherein the user equipment is configured to activate or deactivate, in dependence on the received control signal, a further configuration [e.g., load-adapted or load-specific configuration] [e.g., one out of at least two different further configurations].

For example, the baseline configuration and/or the further configuration(s) can be network energy saving, NES, related configurations. For example, each configuration can be suitable to a different network load, providing a different trade-off between network capacity and network energy saving. These different trade-offs allow to achieve NES.

In embodiments, the further configuration modifies or replaces the baseline configuration.

In embodiments, the baseline configuration is adapted to a first specific load of the wireless communication network.

In embodiments, the further configuration is adapted to a second specific load of the wireless communication network, different from the first specific load.

In embodiments, the baseline configuration is a network energy saving configuration or a high capacity configuration.

In embodiments, the further configuration is a network energy saving configuration or a high capacity configuration.

In embodiments, the baseline configuration defines a plurality of operating parameters of the user equipment.

In embodiments, the plurality of operating parameters include one or more RRC parameters.

In embodiments, the further configuration [e.g., each further configuration of the at least two different further configurations] is configured to, when activated,
set an alternative value to at least one operating parameter of the baseline configuration, and/or
add at least one operating parameter to the baseline configuration, and/or
remove at least one operating parameter from the baseline configuration.

In embodiments, the user equipment is configured to select the further configuration out of at least two different further configurations in dependence on the received control signal.

For example, the user equipment can be configured to activate or deactivate, in dependence on the received control signal, one out of at least two different further configurations.

In embodiments, the at least two different further configurations are adapted to different specific loads [e.g., low load, medium load, high load] and/or specific network requirements [e.g., network energy saving, high capacity] of the wireless communication network.

In embodiments, the at least two different network energy saving configurations define a plurality of operating parameters of the user equipment.

In embodiments, the plurality of operating parameters include one or more RRC parameters.

In embodiments, the received control signal indicates which further configuration out of the plurality of different further configurations is to be activated or deactivated.

In embodiments, each further configuration out of the plurality of different further configurations has an ID associated therewith [e.g., unique ID or non-unique ID when the further configurations are grouped into subsets], wherein the received control signal comprises an information describing the ID of the further configuration to be activated or deactivated.

In embodiments, the user equipment is configured to switch, in dependence on the received control signal,
from the baseline configuration into a further configuration out of the plurality of different network energy saving configurations [e.g., indicated by the control signal],
or from a further configuration out of the plurality of different further configurations into the baseline configuration,
or from a further configuration of the plurality of different further configurations into another further configuration of the plurality of different further configurations [e.g., indicated by the control signal].

In embodiments, the plurality of further configurations are divided into at least two subsets of further configurations, wherein the user equipment is configured to select one out of the at least two subsets of further configurations in dependence on a current operation condition of the user equipment (e.g., time, location) or a second control signal received from the base station, wherein the user equipment is configured to activate or deactivate, in dependence on the current operation condition or on the received control signal, one out of at least two different further configurations of the selected subset of further configurations.

In embodiments, the plurality of further configurations are preconfigured.

In embodiments, the user equipment is configured to receive the plurality of further configurations from the base station [e.g., via a broadcast message or RRC].

In embodiments, the received control signal comprises an information indicating which further configuration out of the plurality of different further configurations is to be activated or deactivated, wherein the information is carried via a higher layer, like an indication in a radio resource control, RRC, layer, or via a media access control, MAC, layer, like an indication in a MAC control element, MAC CE, or via a physical, PHY, layer, like an indication in a downlink control information, DCI.

In embodiments, the control signal or a further control signal comprises an information describing whether one or more operating parameters defined by the further configuration [e.g., one or more of the plurality of different further configurations] is active or inactive, wherein the user equipment is configured to only apply those operating parameters of an active further configuration that are active.

In embodiments, the control signal or a further control signal comprises an information modifying one or more operating parameters defined by the further configuration [e.g., by the one or more of the plurality of different further configurations], wherein the user equipment is configured to modify the one or more operating parameters of the further configuration [e.g. of the one or more plurality of different further configurations] indicated by the control signal or further control signal.

In embodiments, the further configuration [e.g., at least one out of the plurality of different further configurations] indicates an alternative BLER target for measurements.

In embodiments, the BLER target is changed by indicating a CQI table that is different than a CQI table indicated by the baseline configuration.

In embodiments, the further configuration [e.g., at least one out the plurality of different further configurations] define that C-DTX is enabled and that a number of HARQ retransmissions are limited or that HARQ retransmissions are not allowed.

In embodiments, the further configuration [e.g., at least one out the plurality of different further configurations] controls the user equipment to only receive HARQ request on the next Cell-DTX on time or to retransmit only on the next Cell-DTX on time.

In embodiments, one or more out of the baseline configuration and the further configuration [or plurality of different further configurations] define that when C-DTX is de-activated all UE C-DRX parameters apply, wherein one or more other out of the baseline configuration and the further configuration [e.g., plurality of different further configurations] define that C-DTX is activated and that one or more parameters of the C-DRX parameters are modified and remaining parameters remain the same.

In embodiments, the user equipment is configured, if the C-DTX cycle is a multiple of the C-DRX cycle or the C-DRX cycle is a multiple of the C-DTX cycle, to select the largest of the two cycles.

In embodiments, the user equipment is configured, if the C-DTX cycle is not a multiple of the C-DRX cycle or the C-DRX cycle is not a multiple of the C-DTX cycle, to apply the C-DTX cycle when C-DTX is active.

In embodiments, the user equipment is configured to operate in a dual connectivity mode in which the user equipment is connected to different cell groups, wherein the user equipment is configured to deactivate the dual connectivity mode [e.g., to switch into a single connectivity mode] when a control signal received from one of the base stations of the different cells indicates a configuration in which C-DTX is disabled.

In embodiments, the user equipment is configured to operate in a dual connectivity mode in which the user equipment is connected to different cell groups, wherein the user equipment is configured, in case that the different cell groups operate in C-DTX modes having different periodicity, to select [e.g., activate] a further configuration corresponding to the C-DTX mode having the smaller periodicity.

In embodiments, the baseline configuration defines an SSB configuration having SSB transmissions with a first periodicity, wherein a further configuration [e.g., of the plurality of different further configurations] defines an additional SSB configuration having SSB transmissions with a second periodicity, wherein the second periodicity is smaller than the first periodicity.

In embodiments, the SSB transmissions of the further configuration have an independent periodicity with respect to the SSB transmissions of the baseline configuration, or wherein the additional SSB configuration has a timing that complements a timing of the SSB configuration [e.g., to effect a behavior of a shorter SSB period].

In embodiments, the SSB transmissions are NCD-SSB transmissions.

In embodiments, a further configuration [e.g., of the plurality of different further configurations] defines a Cell-DTX or Cell-DRX mode based on a bitmap which divides the time into smaller periods and specifies for those subperiods in which subperiods the Cell will stop transmission or reception and which subperiods the cell will resume transmission or reception.

In embodiments, the control signal comprises a control information [e.g., downlink control information, DCI], wherein the control information signals whether the further configuration is to be activated or deactivated or which further configuration out of a plurality of different further configurations is to be activated or deactivated.

In embodiments, the user equipment is configured to receive the control signal comprising the control information periodically [e.g., independent on whether the further configuration is activated or deactivated [or independent on whether one of the plurality of further configurations is activated or deactivated]].

In embodiments, the user equipment is configured to receive the control signal comprising the control information with a first periodicity in case that the further configuration is deactivated [e.g., the baseline configuration is activated], wherein the user equipment is configured to receive the control signal comprising the control information with a second periodicity, different from the first periodicity, in case that the further configuration is activated.

In embodiments, the further configuration is a network energy saving configuration in which the user equipment operates in a cell discontinuous transmission, C-DTX, mode of operation, wherein the user equipment is configured to receive the control signal comprising the control information with the second periodicity in on-periods of the cell discontinuous transmission, C-DTX, mode of operation, wherein the user equipment is configured to receive the control signal comprising the control information with a third periodicity, different from the first periodicity and the second periodicity, in on-periods of the cell discontinuous transmission, C-DTX, mode of operation.

In embodiments, the further configuration is a network energy saving configuration in which the user equipment operates in a cell discontinuous reception, C-DRX, mode of operation, wherein the user equipment is configured to receive the control signal comprising the control information only in on-durations of the cell discontinuous reception, C-DRX, mode of operation or with a defined time offset to the on-durations of the cell discontinuous reception, C-DRX, mode of operation or only in active durations of the cell discontinuous reception, C-DRX, mode of operation.

Further embodiments provide a base station [e.g., eNB] of a wireless communication network [e.g., 5G/NR], wherein the base station is configured to transmit a control signal to a user equipment of the wireless communication network, wherein the control signal is configured to control the user equipment to activate or deactivate a further configuration.

In embodiments, the further configuration modifies or replaces a baseline configuration based on which the user equipment is configured to operate.

In embodiments, the baseline configuration is adapted to a first specific load of the wireless communication network.

In embodiments, the further configuration is adapted to a second specific load of the wireless communication network, different from the first specific load.

In embodiments, the baseline configuration is a network energy saving configuration or a high capacity configuration.

In embodiments, the further configuration is a network energy saving configuration or a high capacity configuration.

In embodiments, the baseline configuration defines a plurality of operating parameters of the user equipment.

In embodiments, the plurality of operating parameters include one or more RRC parameters.

In embodiments, the further configuration [e.g., each further configuration of the at least two different further configurations] is configured to, when activated,
set an alternative value to at least one operating parameter of the baseline configuration, and/or
add at least one operating parameter to the baseline configuration, and/or
remove at least one operating parameter from the baseline configuration.

In embodiments, the control signal is configured to control the user equipment to activate or deactivate a further configuration out of at least two different further configurations.

In embodiments, the at least two different further configurations are adapted to different specific loads [e.g., low load, medium load, high load] and/or specific network requirements [e.g., network energy saving, high capacity] of the wireless communication network.

In embodiments, the at least two different network energy saving configurations define a plurality of operating parameters of the user equipment.

In embodiments, the plurality of operating parameters include one or more RRC parameters.

In embodiments, the control signal indicates which further configuration out of the plurality of different further configurations is to be activated or deactivated by the user equipment.

In embodiments, each further configuration out of the plurality of different further configurations has an ID associated therewith [e.g., unique ID or non-unique ID when the further configurations are grouped into subsets], wherein the control signal comprises an information describing the ID of the further configuration to be activated or deactivated.

In embodiments, the control signal is configured to control the user equipment to switch,
from the baseline configuration into a further configuration out of the plurality of different network energy saving configurations [e.g., indicated by the control signal],
or from a further configuration out of the plurality of different further configurations into the baseline configuration,
or from a further configuration of the plurality of different further configurations into another further configuration of the plurality of different further configurations [e.g., indicated by the control signal].

In embodiments, the plurality of further configurations are divided into at least two subsets of further configurations, wherein the base station is configured to transmit a second control signal to the user equipment, the second control signal associating each of the at least two subsets of further configurations to a specific operating condition of the user equipment, or the second control signal indicating which subset of the at least two subsets is to be activated by the user equipment.

In embodiments, the base station is configured to provide the baseline configuration and/or the plurality of further configurations by means of pre-configuration or a control message [[e.g., via a broadcast message or RRC].

In embodiments, the control signal comprises an information indicating which further configuration out of the plurality of different further configurations is to be activated or deactivated by the user equipment, wherein the information is carried via a higher layer, like an indication in a radio resource control, RRC, layer, or via a media access control, MAC, layer, like an indication in a MAC control element, MAC CE, or via a physical, PHY, layer, like an indication in a downlink control information, DCI.

In embodiments, the control signal or a further control signal comprises an information describing whether one or more operating parameters defined by the further configuration [e.g., one or more of the plurality of different further configurations] is active or inactive.

In embodiments, the control signal or a further control signal comprises an information modifying one or more operating parameters defined by the further configuration [e.g., by the one or more of the plurality of different further configurations].

In embodiments, the base station is configured to transmit the control signal to a group of user equipments comprising at least two user equipments.

In embodiments, the base station is configured to repeatedly transmit the control signal to the group of user equipments.

In embodiments, control signal comprises an information describing at which time the configuration indicated by the control signal becomes valid [e.g., at which time the further configuration is to be activated or deactivated].

In embodiments, the control signal comprises an information describing how long the configuration indicated by the control signal maintains valid [e.g., how long the further configuration indicated by the control signal is to be maintained active].

In embodiments, the base station is configured, in case that the user equipment does not respond according to the configuration indicated in the control signal, to retransmit the control signal according to the configuration previously used by the user equipment and/or to transmit a wake-up signal to the user equipment.

In embodiments, the further configuration [e.g., at least one out of the plurality of different further configurations] indicates an alternative BLER target for measurements.

In embodiments, the BLER target is changed by indicating a CQI table that is different than a CQI table indicated by the baseline configuration.

In embodiments, the further configuration [e.g., at least one out the plurality of different further configurations] define that C-DTX is enabled and that a number of HARQ retransmissions are limited or that HARQ retransmissions are not allowed.

In embodiments, the further configuration [e.g., at least one out the plurality of different further configurations] controls the user equipment to only receive HARQ request on the next Cell-DTX on time or to retransmit only on the next Cell-DTX on time.

In embodiments, one or more out of the baseline configuration and the further configuration [or plurality of different further configurations] define that when C-DTX is de-activated all UE C-DRX parameters apply, wherein one or more other out of the baseline configuration and the further configuration [e.g., plurality of different further configurations] define that C-DTX is activated and that one or more parameters of the C-DRX parameters are modified and remaining parameters remain the same.

In embodiments, the baseline configuration defines an SSB configuration having SSB transmissions with a first periodicity, wherein a further configuration [e.g., of the plurality of different further configurations] defines an additional SSB configuration having SSB transmissions with a second periodicity, wherein the second periodicity is smaller than the first periodicity.

In embodiments, the SSB transmissions of the further configuration have an independent periodicity with respect to the SSB transmissions of the baseline configuration.

In embodiments, the additional SSB configuration has a timing that complements a timing of the SSB configuration [e.g., to effect a behavior of a shorter SSB period].

In embodiments, the SSB transmissions are NCD-SSB transmissions.

In embodiments, a further configuration [e.g., of the plurality of different further configurations] defines a Cell-DTX or Cell-DRX mode based on a bitmap which divides the time into smaller periods and specifies for those subperiods in which subperiods the Cell will stop transmission or reception and which subperiods the cell will resume transmission or reception.

In embodiments, the base station is configured to transmit the control signal comprising a control information [e.g., downlink control information, DCI], wherein the control information signals whether the further configuration is to be activated or deactivated or which further configuration out of a plurality of different further configurations is to be activated or deactivated.

In embodiments, the base station is configured to transmit the control signal comprising the control information periodically [e.g., independent on whether the further configuration is activated or deactivated [or independent on whether one of the plurality of further configurations is activated or deactivated]].

In embodiments, the base station is configured to transmit the control signal comprising the control information with a first periodicity in case that the further configuration is deactivated [e.g., the baseline configuration is activated], wherein the base station is configured to transmit the control signal comprising the control information with a second periodicity, different from the first periodicity, in case that the further configuration is activated.

In embodiments, the further configuration is a network energy saving configuration in which the base station operates in a cell discontinuous transmission, C-DTX, mode of operation, wherein the base station is configured to transmit the control signal comprising the control information with the second periodicity in on-periods of the cell discontinuous transmission, C-DTX, mode of operation, wherein the base station is configured to transmit the control signal comprising the control information with a third periodicity, different from the first periodicity and the second periodicity, in on-periods of the cell discontinuous transmission, C-DTX, mode of operation.

In embodiments, the further configuration is a network energy saving configuration in which the base station operates in a cell discontinuous reception, C-DRX, mode of operation, wherein the base station is configured to transmit the control signal comprising the control information only in on-durations of the cell discontinuous reception, C-DRX, mode of operation or with a defined time offset to the on-durations of the cell discontinuous reception, C-DRX, mode of operation or only in active durations of the cell discontinuous reception, C-DRX, mode of operation.

Further embodiments provide a method for operating a user equipment of a wireless communication network. The method comprises a step of operating the user equipment using a baseline configuration. Further, the method comprises a step of receiving a control signal from a base station of the wireless communication network. The method comprises a step of activating or deactivating, in dependence on the received control signal, a further configuration [e.g., load-adapted or load-specific configuration] [e.g., one out of at least two different further configurations].

Further embodiments provide a method for operating a base station of a wireless communication network. The method comprises a step of transmitting a control signal to a user equipment of the wireless communication network, wherein the control signal is configured to control the user equipment to activate or deactivate a further configuration.

Embodiments described herein allow the network to configure and re-configure the UE very dynamically to achieve large network energy savings.

Embodiments provide an enhanced cell DTX/DRX mechanism including the alignment of cell DTX/DRX and UE DRX in RRC connected mode and inter-node information exchange on cell DTX/DRX.

Embodiments provide a generalized signaling which allows to change NES states (e.g., including, but not limited to, Cell-DTX and Cell-DRX.

Embodiments allow Cell-DTX work with C-DRX.

Embodiments provide an improved CQI reporting (new BLER target) for Cell-DTX.

Embodiments provide SSB period adaptation using NCD-SSBs.

Embodiments described herein allow for the network to save much more energy while adapting the configuration quickly to different traffic loads.

Subsequently, specific embodiments of the present invention are described in further detail.

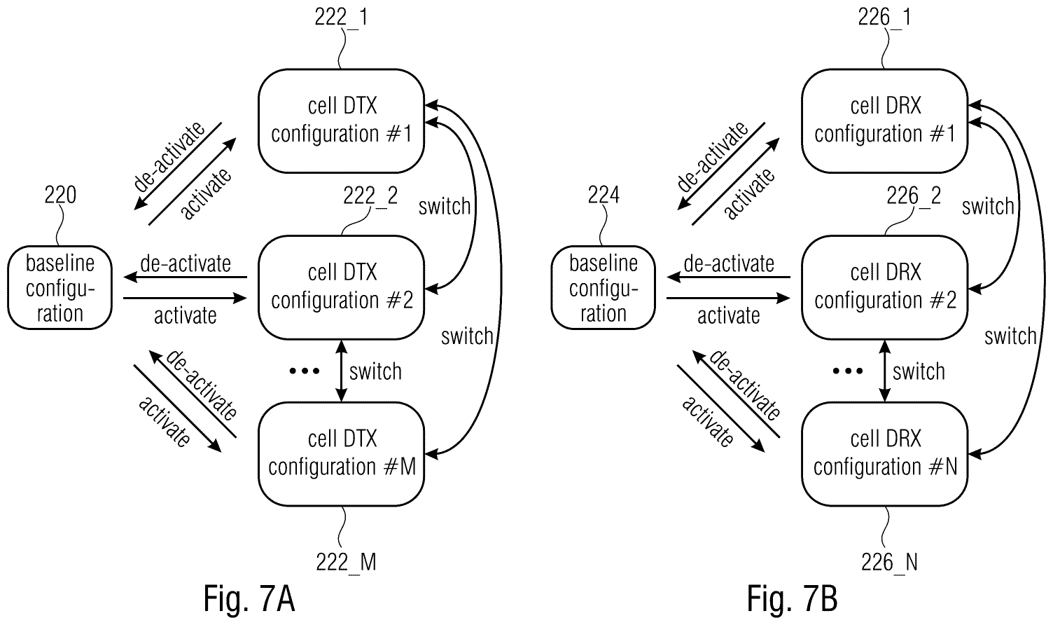

Some embodiments provide a concept for network energy saving (e.g., Cell DTX and Cell DRX) considering a baseline UE configuration and one or more further configurations (e.g., Cell DTX/DRX configurations) which can be signaled to the UE. A certain configuration can be activated or de-activated as illustrated in FIGS. 7a and 7b. It may also be made possible to switch directly from a further configuration to another, without needing to apply the baseline configuration first. Thereby, in FIGS. 7a and 7b it is assumed by way of example that the further configurations are Cell DTX and Cell DRX configurations, respectively.

In detail, FIG. 7a shows a schematic representation of different configurations based on which a UE can be configured to operate, where the different configurations include a baseline configuration 220 and a plurality of further configurations 222_1-222_M, such as Cell DTX configurations. Thereby, the UE can be configured to activate or deactivate in dependence from a control signal received from a base station of the wireless communication system one out of the plurality of further configurations 222_1-222_M.

FIG. 7b shows a schematic representation of different configurations based on which a UE can be configured to operate, where the different configurations include a baseline configuration 224 and a plurality of further configurations 226_1-226_N, such as Cell DRX configurations. Thereby, the UE can be configured to activate or deactivate in dependence from a control signal received from a base station of the wireless communication system one out of the plurality of further configurations 226_1-226_N.

In other words, FIGS. 7a and 7b show that the network can signal to the UE different Cell DTX and/or Cell DRX configurations. The configurations may be activated or de-activated. A configuration can be switched to any of the other ones.

In embodiments, the different configurations (e.g., baseline, Cell DTX and Cell DRX) can be implemented, for example, as RRC configuration, but also by means of any other configuration/technique.

In embodiments, the baseline configuration can be, for example,
a configuration without any Cell DTX or Cell DRX configuration,
a configuration with a default Cell DTX configuration and no Cell DRX configuration,
a configuration with no Cell DTX configuration and a default Cell DRX configuration, or
a configuration with both a default Cell DTX configuration and a default Cell DRX configuration.

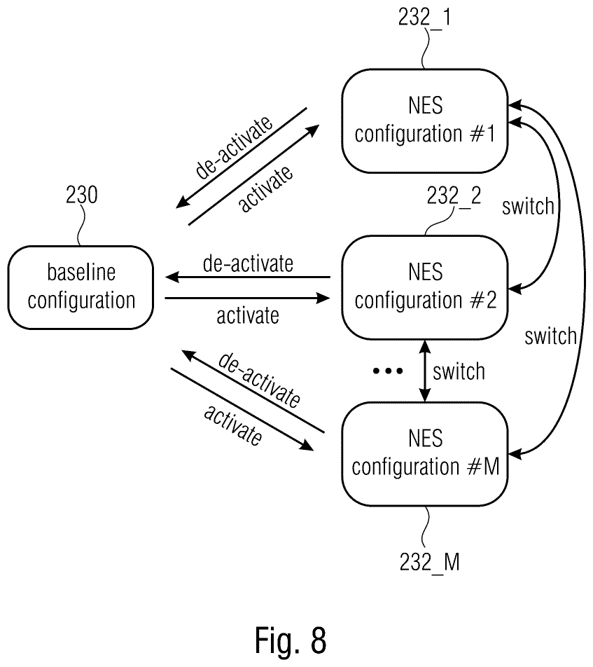

It is noted that embodiments of the present invention not only can be applied for Cell DTX and Cell DRX but also for network energy saving (NES) features in general. This is illustrated in FIG. 8.

In detail, FIG. 8 shows a schematic representation of different configurations based on which a UE can be configured to operate, where the configurations include a baseline configuration 220 and a plurality of further configurations 232_1-232_M, such as NES configurations. Thereby, the UE can be configured to activate or deactivate in dependence from a control signal received from a base station of the wireless communication system one out of the plurality of further configurations 232_1-232_M. In other words, FIG. 8 shows that different configurations can be applied to switch between different network states in order to support NES.

In embodiments, a NES configuration may include Cell DTX configuration, Cell DRX configuration and/or configuration of other NES features. In essence, it includes configurations which are appropriate for different load situations and the signaling described in embodiments allows the network to inform UEs of the changes in order to swiftly switching between NES modes and high capacity modes.

In embodiments, the general idea is, as illustrated in FIG. 8, to configure the UE with multiple NES-related configuration setups upfront and apply the changes (e.g., activate, de-activate or switch) more dynamically as the network load varies. Each configuration can be given for example an ID which allows the UE to recall the configuration when signaled it should activate, de-activate or switch to the configuration identified with that ID. For example, the RRC configuration may specify the amount of bits used for ID signaling on DCI or MAC CE.

In the following description it is exemplarily assumed that the further configurations are NES configurations. However it is noted that the present invention is not limited to such embodiments. Rather, in accordance with embodiments, the further configurations also can be any other kind of configurations that are adapted to different load situations, such as load adapted configurations or load dependent configuration.

In embodiments, a NES configuration can comprise (or consists of) a set of parameters applicable when the network signals to the UE that such configuration is active. A configuration may become active by, e.g., activation (e.g., from baseline configuration) or switching from a different configuration. A certain configuration may include one or more out of
zero or more parameters which are set to a different value, i.e., the value on the NES configuration should be used instead of a corresponding parameter value on the baseline configuration,
zero or more parameters which are added, i.e., parameters which do not exist on the baseline configuration but are applied in a NES configuration,
zero or more parameters which are removed, i.e., parameters which exist on the baseline configuration but are not anymore applicable when a NES configuration is activated.

Subsequently, three none limiting examples of different configurations are provided.

According to a first example, on the baseline configuration, the gNB can configure UEs with C-DRX parameters. The gNB can inform the UEs that a Cell DTX mode is now applicable and therefore the UEs should modify their RRC C-DRX parameters to the corresponding Cell-DTX parameter values. This example is further elaborated in section 4.1.

According to a second example, a baseline configuration can be set such that the network operates with sparse SSB occasions (e.g., every 80 ms). The gNB can inform UEs that a new configuration applies where extra SSBs are added in a way which achieves a corresponding 20 ms periodicity. This example is further elaborated in section 4.2.

According to a third example, a baseline configuration can be set such that the UEs measure a certain number of PUCCH/SR resources. A Cell DTX configuration informs the UE of a list of PUCCH/SR resources which are not to be measured anymore (e.g., to be removed from configuration). This example is further elaborated in section 4.3.

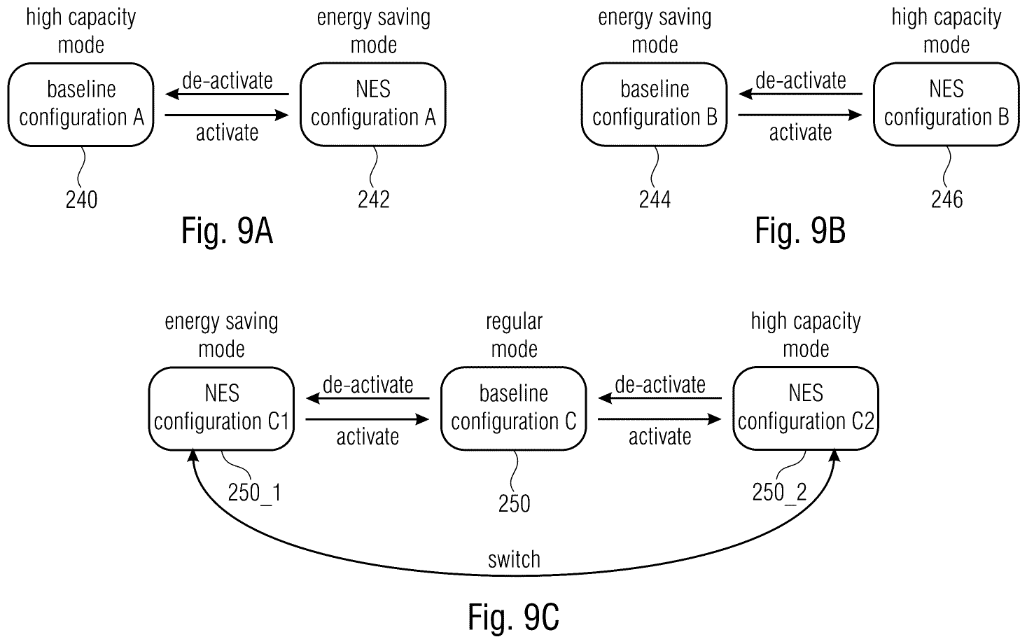

The inventive concept is highly flexible and it allows for many different network implementations. This is illustrated in FIGS. 9a-9c, which shows a schematic representation of an exemplarily embodiment of the present invention.

In detail, FIG. 9a shows a schematic representation of different configurations based on which a UE can be configured to operate, where the different configurations include a baseline configuration A 240 and a further configuration 242, such as a NES configuration A. FIG. 9b shows a schematic representation of different configurations based on which a UE can be configured to operate, where the different configurations include a baseline configuration B 244 and a further configuration 246, such as a NES configuration B. FIG. 9c shows a schematic representation of different configurations based on which a UE can be configured to operate, where the different configurations include a baseline configuration C 250 and two further configurations 252_1 and 252_2, such as a NES configuration C1 252_1 and a NES configuration C2 252_2. Thereby, the UE can be configured to activate or deactivate in dependence from a control signal received from a base station of the wireless communication system one out of the different configurations 242, 246, 250_1 and 250_2, respectively.

In the example of FIG. 9a, the UEs are configured by default in a high capacity mode (e.g., DTX/DRX off, frequent SSB transmission) and through activation of the NES configuration A, an energy saving mode (e.g., DTX/DRX on, sparse SSB transmission) can be achieved. This is a way of implementation from the view of that there is a current mode of operation of the network and Cell DTX/DRX is achieved mostly by turning off things which are typically on. The example of FIG. 9b goes in a totally different direction. The UEs are configured by default on a network energy saving mode (e.g., sparse SSB allocation, few RACH resources, sparse RS resources) and the network adds extra configuration (e.g., NES configuration B) to achieve high performance. A strong merit of this approach is that the baseline configuration can be also made applicable to legacy UEs, i.e., the network energy saving state can be achieved also with legacy UEs. Note that in such an exemplarily case, a configuration can be added to achieve a state which is neither DTX nor DRX. Such state can be called, for example, “enhanced transmission”.

Using the inventive concept, even more complex embodiments are possible enabling the network to adapt to many different load situations. This is illustrated by way of example in FIG. 9c where the baseline configuration is adapted (e.g., good) for a variety of situations, but the extra configurations can be activated to either increase energy savings or to boost capacity. The example of FIG. 9c can be seen as a combination of the examples of FIGS. 9a and 9b.

In embodiments, in order to reduce the signaling overhead, the complete set of possible configuration may be sub-divided into sub-sets. A use case of having sub-sets is to have a different set of configurations to be applied on different time periods. Typically, the load distribution of a cell varies over the day and a different pattern is also observable on different days, such as workdays and weekend. As an example of the need, it is supposed that 8 NES configurations are needed for workdays and 8 are needed for the weekend. If all 16 configurations are pre-configured, every lower layer signaling (e.g., DCI or MAC CE) would need to include a 4 bit indication of the configuration ID. As previously described the number of bits for configuration ID may be set on the RRC configuration. Instead of setting all 16 configurations, the network may indicate the UE whether it is currently using the workday subset (e.g., composed of 8 configurations) or the weekend subset (e.g., composed of 8 configurations). Such indication can be sent, for example, only once per day, but in all configuration changes within that day only 3 bits would be needed to apply changes. The RRC configuration may include subset IDs and changing the currently applicable subset may be done via MAC CE or DCI.

Alternatively, the changes between different subsets may be even pre-configured, to occur based on time of day, day of the week or another measure of time such as subframe number.

### 1. FAST ACTIVATION/DE-ACTIVATION

In principle, it is already possible (in Release-17) to create gaps in the time allocation of a cell by reconfiguring C-DRX of the UEs, even without the introduction of Cell DTX and DRX features. In this legacy mechanism the RRC signaling needs to be done to all UEs one by one. Thus, entering or leaving an energy saving state with legacy mechanism is cumbersome and would take a lot of time and signaling overhead. Therefore, a quicker way to activate and de-activate Cell DTX/DRX is an important aspect to achieve a smooth adaptation to traffic load variations.

As described in [5], Cell DTX/DRX activation/de-activation could be done more quickly by considering dynamic L1/L2 signaling. In this section, embodiments are described which provide a more dynamic activation and de-activation.

In embodiments, and exemplarily making reference to FIGS. 7a and 7b, the different configurations can be done, for example, at RRC level. The different configurations may be, for example, pre-configured, broadcasted via system information (e.g., periodically or on-demand) or sent via dedicated RRC signaling (e.g., RRC connection setup, RRC connection reconfiguration, RRC connection release). When an embodiment contains more than one configuration these different possibilities may be combined, for example: one configuration is pre-configured, another configuration is sent in SI (system information), another configuration on dedicated signaling.

In embodiments, and exemplarily also making reference to FIGS. 7a and 7b, the three different configuration change transitions (e.g., activate, de-activate, switch) may be signaled on different levels:
RRC level,
as a MAC CE (L2), and/or
as DCI (L1).

In embodiments, the usage of DCI can be particularly adequate for dynamic activation, de-activation and switch because with DCI it is possible to support group signaling in a dynamic way. The DCI may be sent with some specific RNTI, e.g., NES-RNTI.

In embodiments, the activation or switch in MAC CE or DCI may be signaled by a configuration ID where each configuration ID can pre-defined, for example, at RRC level and associated to a particular configuration. The de-activation may also be done via the baseline configuration ID or via a special command to return to baseline configuration.

While fast activation and de-activation solves the problems of the legacy signaling (e.g., being able to more quickly follow traffic variations and therefore saving more energy), a group signaling, e.g., based on a new DCI format, carry a substantial danger. Specifically, some of the UEs may not receive the signaling which changes the configuration. Therefore, the UE would still apply a different configuration than the one intended and in fact such UE would very likely wake up when the cell is sleeping and vice-versa. In order to avoid such situation embodiments provide different solutions, which are discussed in the following.

In embodiments (solution 1), the group signaling can be repeated multiple times, in order to minimize the probability that some UE is out of sync in the applied configuration. In embodiments, this may be accompanied with introducing a counter or timer for applying the configuration such that the change can be made effectively at the same time for all UEs. One way to do so is adding a timing information, e.g., an IE, providing the time when the new/changed NES or baseline configuration should apply. This timing information could be an absolute time or a relative time, e.g., x ms providing the offset from the time the message is received until the new configuration should be used.

In embodiments (solution 2), the state where Cell-DTX is active can be made the default state. The signaling then can be done to disable Cell-DTX (e.g., apply continuous transmission). Once the Cell-DTX OFF state is set, a timer can be started. If the gNB wants to keep the Cell-DTX OFF, it has to re-signal (e.g., refresh) the timer periodically. So implicitly if the UE does not receive any signal it will switch back to the Cell-DTX active state.

In embodiments (solution 3), if a UE does not answer to a certain PDCCH message sent on a certain Cell-DTX state (e.g., no HARQ feedback) the gNB can repeat the PDCCH message also at the time which would be applicable on the other state.

In embodiments (solution 4), if the gNB can determine the UE is not answering as expected (as above, e.g., the UE is not sending HARQ feedback to a certain scheduling) the gNB sends a WUS (wake-up signal) to the UE or a group-WUS to applicable to any UE.

### 2. MODULAR ACTIVATION/DEACTIVATION

For the sake of flexibility, some embodiments allow activating and/or de-activating one or more of the following:
Common signals Cell-DTX
PDCCH/Shared channel Cell-DTX
RACH Cell-DRX
SR/PUCCH/CG-PUSCH Cell-DRX

In some embodiments, all or a subset of these functions can be activated or de-activated at the same time. For this sake configurations may be bundled. This is particularly true if group signaling is considered. In order to maximize energy savings during fast traffic changes, a mechanism to perform fast group signaling may be advantageous in some embodiments.

In embodiments, group signaling can be implemented using a new DCI format. Some possibilities for this new DCI format are described subsequently.

For example, a new DCI format may include a 1-bit indication of whether Cell DTX/DRX bundle A is in use or Cell DTX/DRX bundle B is in use.

For example, a new DCI format may include a N-bit indication of the NES configuration ID. The RRC configuration associates each configuration with a NES configuration ID. The number of bits used for configuration ID indication may be set via RRC signaling.

For example, a new DCI format may include separate 1-bit indications whether
common signals Cell-DTX is activated or de-activated,
PDCCH/shared channel Cell-DTX is activated or de-activated,
RACH Cell-DRX is activated or de-activated, and/or
SR/PUCCH/CG-PUSCH Cell-DRX is activated or de-activated.

In embodiments, it is also possible to consider other granularities and combining some of the sub-features. Furthermore, a fine-granular activation and de-activation of Cell DTX and Cell DRX modes can be considered. In embodiments, a Cell DTX configuration may contain, for example, one or more out of the following:
whether SSBs are transmitted or not and SSB periodicity if transmitted,
whether SSBs contain MIB or not,
whether SIB-1 is transmitted or not and SIB-1 periodicity if transmitted,
whether other SIBs are transmitted or not and their periodicity if transmitted,
whether CSI-RS are transmitted or not and CSI-RS periodicity if transmitted,
whether TRS are transmitted or not.

Similarly, even though sub-features of Cell DTX and Cell DRX may be considered at fine granularity of configuration, the activation and de-activation can be typically be performed together. For that sake, in accordance with embodiments, there are two main approaches:
the configuration is bundled and the network signals which bundle is currently valid, or
in the activation/de-activation/modification message each subfeature is activated/de-activated independently.

### 3. MODIFIED BLER TARGET DURING CELL DTX

In C-DRX, HARQ retransmissions have a special treatment. The UE needs to wake up again to receive PDCCH and the corresponding PDSCH scheduling of a HARQ retransmission. As part of the C-DRX parameters, the network informs when a UE can expect the retransmission time. Even with this optimized mechanism, which allows the UE to microsleep between the first transmission and retransmission, having more retransmissions will take a toll on the UE energy saving. Still, for example, for CQI with the usual BLER target of 10% and assuming link adaptation picks MCS accordingly, the UE may sleep further after 90% of first transmissions and only needs to wake up to receive a re-transmission only in 10% of the cases.

From the network perspective, this HARQ retransmission problem takes a different dimension. A cell may serve many UEs and if even a single UE needs a retransmission it means the cell cannot sleep. Statistically, a BLER target of 10% means there are following chances for the cell to sleep (considering a binomial distribution):

| | Probability that no UE needs a retransmission |
|---|---|
| Number of UEs | (so the cell can further sleep) |
| 1 | 90% |
| 2 | 81% |
| 3 | 72.9% |
| 4 | 65.6% |
| 5 | 59.5% |
| 10 | 34.9% |

It can be seen that even for a small to moderate number of UEs the ability of a cell to really sleep in Cell-DTX is severely impacted by retransmissions. An optimal network embodiment would attempt to avoid retransmissions by increasing the reliability during Cell-DTX, e.g., setting more robust MCSs with conservative data rates. However, there is a problem with that. The CQI reporting is based on very specific BLER targets so that the network can achieve the such target quite precisely in the first transmission (e.g., initial BLER), using a combination of power control and link adaptation. And, with the HARQ retransmissions the residual BLER can be further reduced subject to the latency limitations of the application. Turning HARQ retransmission off with arbitrary choice of lower MCSs for robustness will not be optimal since it is difficult to achieve a desired BLER and data rate precisely.

In order to solve this problem in a precise way, in accordance with embodiments, a Cell-DTX configuration (e.g., corresponding to an energy saving state/Cell-DTX ON) may include also a different BLER target compared to other configurations.

[6] section 5.2.2.1 defines that the UEs shall measure and report CQI based on a transport block error probability of 10%, if table 1 or 2 of [6] are configured and 0.001% if table 3 of [6] is configured:

In order to solve the aforementioned problem of a cell always being awake to serve some retransmissions, some embodiments can use a different CQI table in different Cell-DTX configurations. For example, referring to FIG. 9a, the baseline configuration may use table 1 or 2 of [6] and the Cell-DTX configuration may use table 3 of [6]. In reference to FIG. 9b the implementation may be exactly the opposite: the baseline configuration may use table 3 of [6] whereas the Cell-DTX configuration uses table 1 or 2 of [6].

0.001% target BLER (table 3 of [6]) can be overkill (e.g., too conservative) for a Cell-DTX state and have other undesired implications such as too much resource usage. Therefore, some embodiments provide intermediate CQI tables which fit different BLER targets, e.g., 1%, 0.1% or 0.01% in order to apply the concept described in this section. Having at least one more value would be quite valuable for implementation.

Another possibility to assure the energy saving gains is that HARQ retransmissions are completely prohibited during Cell-DTX ON and re-enabled during Cell-DTX OFF. More conservatively, the number of HARQ retransmissions can be limited (e.g., to one or two) during Cell-DTX ON and unlimited (or larger limit) during Cell-DTX OFF.

In some embodiments, retransmissions can be avoided by forcing UEs to only hear HARQ request on the next Cell-DTX ON time, or by letting UEs freely listen to HARQ requests but waiting to retransmit only on the next Cell-DTX ON time. One example of such use would be in DSS operation of NR and LTE. Due to LTE, the cell may need to be awaken anyway every 5 ms. Therefore, Cell DTX pattern could be defined with 5 ms period, and perhaps it is acceptable to delay HARQ retransmission by up 5 ms (depends on the traffic requirements).

### 4. EXAMPLES OF SPECIFIC EMBODIMENTS

Subsequently, examples of specific embodiments are described.

### 4.1 Cell-DTX as a Modification of C-DRX Parameter Values

C-DRX is already supported by legacy UEs and it will need to be used to manage legacy UEs on a cell applying Cell-DTX. Furthermore, packing the ON duration of different UEs is the most beneficial possibility for energy saving, while spreading the ON duration of different UEs is the most beneficial configuration for a situation where there is more traffic (because it spreads the load over time).

For those reasons, in accordance with some embodiments, Cell-DTX activation is considered a as a modification of C-DRX parameter values. Namely:
When Cell-DTX is de-activated all UE C-DRX parameters apply.
When Cell-DTX is activated the UE can consider one or more out of the following:
   a subset of parameters is superseded by Cell-DTX parameters, i.e. the Cell-DTX parameter values are used instead of the C-DRX parameter values,
   a remaining subset of parameters which remain the same—the C-DRX parameter values are still used.

For example, the set of the superseded parameters can be a different ON duration parameter is used instead of drx-onDurationTimer when Cell-DTX is in active state. This new parameter may, e.g., be called celldtx-onDuration Timer. Alternatively, the name drx-onDuration Timer can be kept but the applicable value is unambiguous because every configuration (e.g., baseline and other configurations) provides its own value of the parameter.

For example, the set of the superseded parameters can be a cycle and accompanying offset to be used instead of drx-LongCycleStartOffset when Cell-DTX is in active state. This new parameter may, e.g., be called celldtx-LongCycleStartOffset. Alternatively, the name drx-LongCycleStartOffset can be kept but the applicable value is unambiguous because every configuration provides its own value of the parameter.

In such a signaling implementation in accordance with embodiments the network can quickly switch between a situation where the C-DRX ON duration of different UEs is spread over time and a situation where the ON duration is packed in time.

The Cell-DTX configuration may be considered in a dedicated way (e.g., each UE receives its own RRC configuration). In this case, the gNB needs to guarantee the consistency of the configuration with the C-DRX configuration. Another possibility is that the Cell-DTX configuration is valid for a group or all UEs, signaled for example as part of System Information. In this latter case, when a C-DRX cycle is superseded by a Cell-DTX cycle in a group one important issue arises. For some of the UEs in the group the Cell-DTX cycle may actually be smaller than the C-DRX cycle. A simple modification of the value in this case would mean the UE starts consuming more power, which is definitely undesirable. A set of rules and behaviors from the network and UE is needed to cope with that. Some embodiments provide the following solution: in Cell-DTX active mode the UE applies the cycle duration which is larger, either the Cell-DTX cycle or the C-DRX cycle.

As an example, a gNB could be serving UEs with C-DRX cycles of 20 ms, 40 ms and 160 ms. The Cell-DTX cycle is set to 40 ms. During Cell-DTX active period, the UEs with 20 ms C-DRX cycle shall use the 40 ms cycle (which is larger than its own) with the given offset. The UEs with 40 ms C-DRX cycle only need to update the offset (in either case both cycle parameters would lead to the same conclusion->use 40 ms cycle). The UEs with 160 ms C-DRX cycle should, however, keep their own C-DRX cycle albeit with a new offset (the Cell-DTX offset) to achieve the desired alignment.

In embodiments, naturally, instead of superseding C-DRX parameters it is also possible to simply repeat all C-DRX parameters in a Cell-DTX on configuration, but it can be more efficient to just signal the few superseded parameters.

Another issue arises when the C-DRX cycle is incompatible with the intended Cell-DTX cycle. For example, if the C-DRX cycle is of 32 ms and the Cell-DTX cycle is 20 ms the ON and OFF period of both cycles will not match often. In this case even though the UE would consume more power, in embodiments, the C-DRX cycle can be reconfigured with the Cell-DTX cycle. This still can be used in combination with selecting the largest cycle by specifying the UE behavior as follows:
If the Cell-DTX cycle is a multiple of the C-DRX cycle or the C-DRX cycle is a multiple of the Cell-DTX cycle, the UE should select the largest of the two cycles.
If neither condition applies (e.g., not a multiple), during Cell DTX ON the UE shall apply the Cell-DTX cycle.

Naturally, it would be good if each UE can be served by a cycle which fits its traffic. Therefore, in embodiments, the gNB could direct users during Cell-DTX to a cell which has a compatible cycle (e.g., multiple of the UE cycle or vice-versa). For example, in relation to the possible long DRX cycles values in drx-LongCycleStartOffset, the multiples of 32 ms (values ms32, ms64, ms128, ms256, ms1024, ms2048) could be served by one cell (e.g., PCell or Scell) and the values ms10, ms20, ms40 and other multiples of 10 ms could be served by another cell. Then the cycles could be kept most aligned. In order to facilitate that alignment a Cell-DTX configuration could contain a change of PCell or SCell to direct the UE to that cell during Cell-DTX ON state.

When the UE is connected to different cell groups (DC), the alignment becomes even more complicated. In some embodiments, there are 4 cycles in consideration: C-DRX on MCG, C-DRX on SCG, Cell-DTX on MCG and Cell-DTX on SCG. Coordination is needed or at least some UE behavior for solving the conflicts is needed. Some embodiments provide the following options for this case.

In embodiments (option 1), the 2 gNBs can coordinate via Xn to make sure no UE has an incompatible Cell-DTX alignment on 2 cells.

In embodiments (option 2), DC can be deactivated if one of the cells goes into Cell-DTX. For example, if the SCG enters Cell-DTX DC simply can be de-activated. For example, if the MCG enters Cell-DTX the SCG becomes MCG and DC can be de-activated. For example, if both cells try to enter Cell-DTX at the same time, the UE follows Cell-DTX of MCG and DC can be de-activated.

In embodiments (option 3), the gNBs can align their DTX cycle or at least the offset through Xn signaling. If their offset is aligned and the DRX periodicity is chosen among 20, 40, 80 and 160 ms UEs can simply choose the smallest period to follow. As an example, if a cell is using a configuration with 40 ms DTX period and the other is using a configuration with 80 ms DTX period, UE should align its DRX cycle to the configuration with 40 ms period.

In embodiments (option 4), if the UE moves out of the coverage of a cell dual connectivity can be terminated.

In embodiments (option 5), if aligning the Cell-DTX cycles of the two cells is not feasible, some short term signaling may be setup to make punctual adjustments of alignment of PDCCH ON and PDCCH OFF periods. This may involve the use of sending a special wake up signal to the UE and/or PDCCH skipping (SSSG switching). For example, if both cells have data to transmit, the cell which transmits a PDCCH first may send an wake up indication to the UE to indicate that the UE should resume PDCCH listening also in the other cell. For example, when one of the cells has a PDCCH opportunity it may also send a PDCCH skipping indication to the UE relative to the other cell. This may be used, e.g., to let the UE follow just one cycle instead of both.

### 4.2 Common Signals Adaptation with Added NCD SSBs

Common channels adaptations (SSB, SIB-1, RACH adaptations) can provide major energy saving gains. A major issue to introduce dynamic SSB adaptation is that legacy UEs will not understand the changes in SSB configuration. This may be a showstopper, as SSB is very critical for a number of functionalities in 5G NR. Because of that [5] states “technique may be enabled for a carrier only when legacy UEs are not using the carrier” for most common channel adaptations. Embodiments change that. Specifically, some embodiments define an energy saving state which is backward compatible and adaptation which allows to increase network capacity back when needed.

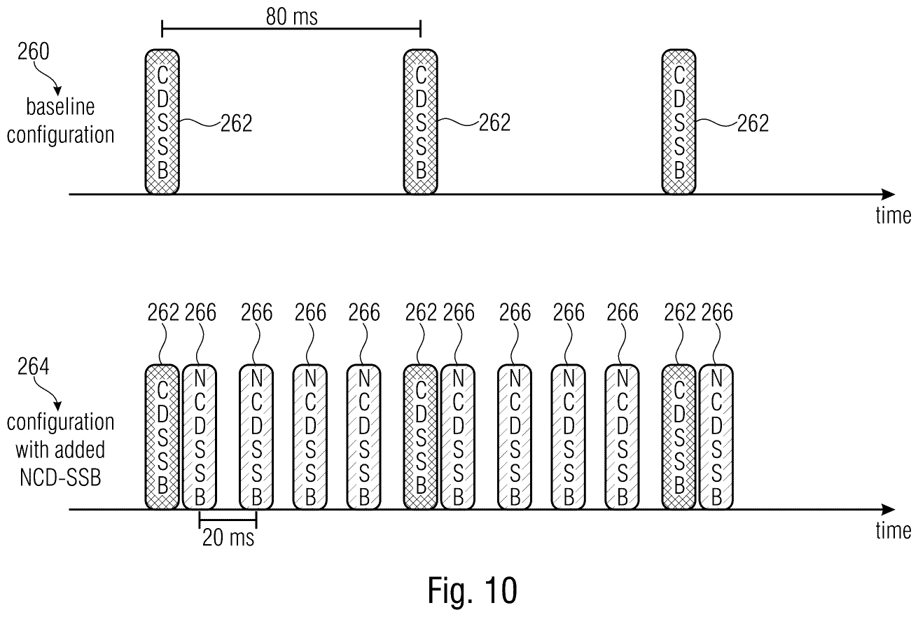

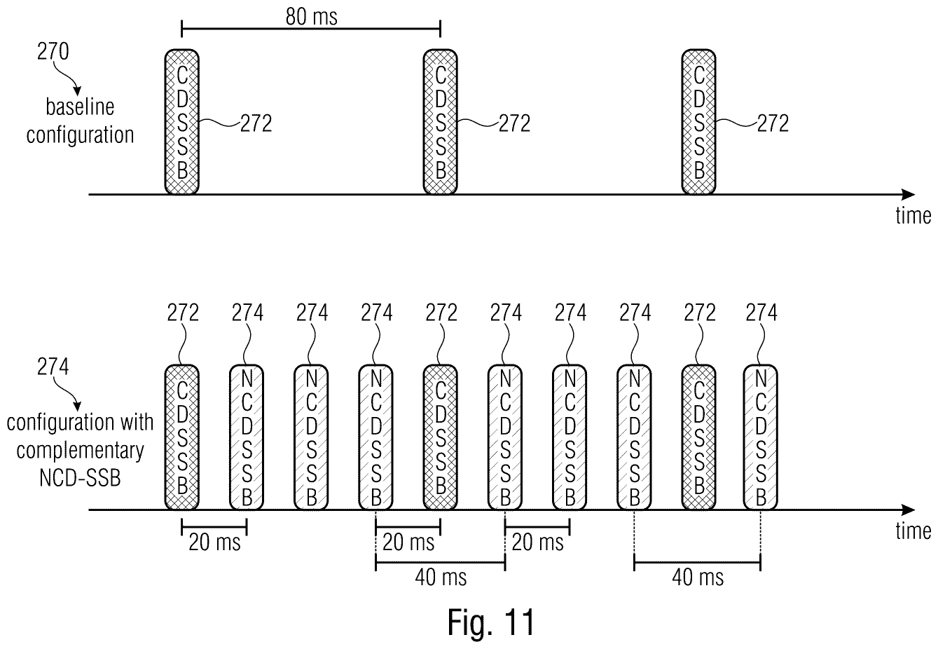

In embodiments, in the case of SSB adaptation this can be done as follows:
The baseline configuration defines only CD-SSBs (cell defining SSBs) with a large periodicity (e.g. 80 ms or 160 ms).
During times the network has more load, NCD-SSB (non-cell defining SSBs) are also transmitted with either:
   smaller periodicity, e.g., 20 ms (see FIG. 10), or
   in a way to exactly complement the CD-SSB (see FIG. 11).
The NES aware UEs are able to adapt measurements to be based only on the CD-SSBs or only NCD-SSBs or even both CD-SSBs and NCD-SSBs

The two sub-approaches are shown in FIG. 10 and FIG. 11.

Specifically, FIG. 10 shows a schematic representation of two different configurations 260 and 264 based on which a UE can operate, where the different configurations include a baseline configuration 260 in which CD-SSBs 262 are transmitted periodically and a further configuration 264 which adds NCD-SSB transmissions 266 having an independent timing in between the CD-SSB transmissions 262. In other words, FIG. 10 shows that NCD-SSBs can added when the NES-related configuration is activated, where the NCD-SSBs can have an independent timing.

FIG. 11 shows a schematic representation of two different configurations 270 and 274 based on which a UE can operate, where the different configurations include a baseline configuration 270 in which CD-SSBs 272 are transmitted periodically and a further configuration 274 which adds NCD-SSB transmissions 276 having a dependent timing in between the CD-SSB transmissions 272. In other words, FIG. 11 shows that NCD-SSBs can be added when the NES-related configuration is activated, where the NCD-SSB complements the timing of the CD-SSB to emulate the behavior of shorter SSB period.

In embodiments, the network sets the baseline configuration with sparse SSBs and when needed it activates configuration which contains extra SSBs. These extra SSBs can be implemented, for example, as NCD-SSBs. In FIG. 10 the added NCD-SSB have an independent timing to the CD-SSBs. For the sake of periodical measurements the UE would typically be set with either measurements of the CD-SSBs or measurements of the NCD-SSBs.

In FIG. 11 the timing and offset of the NCD-SSBs are used exactly to complement the CD-SSB as if a shorter periodicity was used in the first place. Note that in that case the period between NCD-SSBs is not fixed (in the example varies between 20 ms and 40 ms) but the number of total transmitted SSBs is less than what is shown FIG. 10. Therefore, embodiments with additional NCD-SSBs (FIG. 10) may be advantageous when legacy UEs are present and embodiments with complementary NCD-SSBs (FIG. 11) may be advantageous when only new UEs are present. When using complementary NCD-SSBs the UE measurements can be typically be based on both the CD-SSB and NCD-SSB in order to maintain a fixed measurement period. When NCD-SSBs would be de-activated then the UEs can base measurements on the CD-SSB only.

Note that for simplicity in FIG. 10 and FIG. 11 only 1 SSB per period is illustrated, but in an exemplarily implementation SSBs may be repeated on each beam. The period then can be applied between SSB-bursts, which are in essence repetitions of the same SSB (e.g., same frame number) on different beams (e.g., directions). Therefore, there may be a SSB-burst with CD-SSBs (e.g., where a CD-SSB is illustrated) and SSB-bursts with NCD-SSBs (e.g., where a NCD-SSB is illustrated).

### 4.3 PUCCH/SR Adaptation on Cell-DRX

The network can setup a set of PUCCH resources for the UE to send control information as well as set of Scheduling Requests (SR) s. In Rel-17 the network can already add or remove PUCCH and SR resources with dedicated RRC signaling. In order to have faster adaptation for NES, this could be done also more dynamically using the concept described herein.

In embodiments, the network can provide a list of PUCCH (or SR) resources which are to be removed during the time a certain Cell-DRX configuration is applicable. This list can be associated to a code on either DCI or MAC-CE. When using the baseline configuration the full list of configured PUCCH (or SR) resources is applicable. When a Cell-DRX configuration is activated the resources on the first list are removed from configuration. When the Cell-DRX configuration is de-activated the same resources may be added again.

The logic can also be reversed and the baseline configuration has less PUCCH (or SR) resources than the NES configurations. In this case, the network provides a list of PUCCH (or SR) resources which are to be added when the NES-related configuration is activated. Conversely, when the NES-related configuration is de-activated the smaller set of resources (as provided in the baseline) may be applicable again.

### 4.4 Cell-DTX and Cell-DRX Based on Bitmaps

In some embodiments the Cell-DTX parameters may also take a different form than the C-DRX parameters. For example, instead of having ON and OFF periods defined by a single parameter, in a cell-DTX configuration the UE uses a bitmap which divides the time into smaller periods and specify for those subperiods in which subperiods the Cell will stop transmission and which subperiods the cell will resume transmission. As an example, the bitmap may have 10 positions each corresponding to 1 ms period. A bit set to 1 may indicate the ON periods and bit set to 0 the OFF periods, or vice-versa (1 is OFF and 0 is ON). Then the cell repeats a Cell-DTX pattern provided by the bitmap every 10 ms. A bitmap implementation is also applicable to Cell-DRX.

### 4.5 Monitoring of PDCCH Carrying NES Related DCI

In embodiments, the DCI signaling for activating, de-activating or switching the NES configuration is quite critical for the timeliness of adaptations to the traffic. However, the PDCCH which carries NES-related DCI cannot be continuously monitored, otherwise UE power consumption and UE complexity increases. At the same time it is desirable from network perspective that all UEs can be swiftly informed of changes NES configurations so that the network can adapt forth and back between modes of energy saving and high capacity. This issue is made even more critical by the fact the same NES-related DCI may carry information about multiple cells, for example, PCells and SCells, including, e.g., Cell DTX activation/de-activation, Cell DRX activation/de-activation as well as conditional handover triggers. For all these reasons, the monitoring of PDCCH carrying NES-related DCI needs to be properly designed.

In the following, embodiments are described that allow a UE to periodically monitor PDCCH for the NES-related DCI scrambled with NES specific RNTI (e.g., NES-RNTI or Cell DTX/DRX RNTI).

In some embodiments the monitoring of NES-related DCI can be done periodically independent of the network or UE state(s).

In other embodiments the NES-related DCI can be monitored with a first periodicity when Cell DTX is de-activated and with a different periodicity when the Cell DTX is activated. As a further enhancement, in some embodiments, in addition to the first periodicity (e.g., for Cell DTX de-activated), a second monitoring periodicity applies when cell DTX is activated and during the Cell DTX on-duration while a third monitoring periodicity applies when Cell DTX is activated and during the cell DTX off-duration.

In some embodiments the monitoring of NES-related DCI does not depend on UE C-DRX state. In other embodiments the NES-related DCI is only monitored if the UE is on on-duration.

In other embodiments the UE monitors NES-related DCI only on a certain time offset from the on-duration. In yet other embodiments the NES related DCI is monitored if the UE is on UE-CDRX active duration (on duration, inactivity or retransmission timer running). In some embodiments, the monitoring of NES-related DCI may also be defined to match the occasions of UE power saving commands related DCI.

### 5. FURTHER EMBODIMENTS

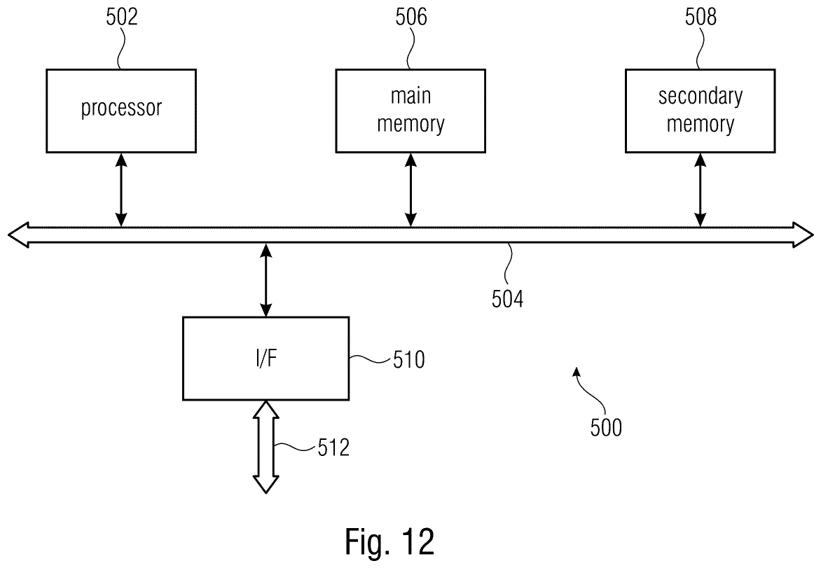

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LIST OF REFERENCES

[1] RP-223540 “New WID: Network energy savings for NR”, TSG-RAN #98-e, December 2022
[2] TS 38.300 v17.3.0 “NR; NR and NG-RAN Overall description”, January 2023
[3] TS 38.321 v17.3.0 “NR; Medium Access Control (MAC) protocol specification”, January 2023
[4] TS 38.321 v17.3.0 “NR; Radio Resource Control (RRC); Protocol specification”, January 2023
[5] TR 38.864 v18.0.0 “Study on network energy savings for NR”, January 2023
[6] TS 38.214 v17.4.0 “NR; Physical layer procedures for data”, January 2023

ABBREVIATIONS

| | |
|---|---|
| 3GPP | third generation partnership project |
| ACK | acknowledgement |
| BFD | beam failure detection |
| BFR | beam failure recovery |
| BRP | beam forming resource pool |
| BS | base station |
| CD-SSB | cell-defining synchronization signal block |
| CDM | code division multiplexing |
| CG | configured grant |
| CRI | CSI-RS resource indicator |
| CQI | channel quality indicator |
| CSI | channel state information |
| CSI-RS | channel state information - reference signal |
| D2D | device-to-device |
| DC | dual conectivity |
| DCI | downlink control information |
| DL | downlink |
| DM-RS | demodulation reference signal |
| DRX | discontinues reception |
| DTX | discontinues transmission |
| eNB | evolved node B |
| FR1 | frequency range one |
| FR2 | frequency range two |
| gNB | next generation node B |
| HARQ | hybrid automatic repeat request |
| ID | identity |
| IFFT | inverse fast Fourier transform |
| IoT | internet of things |
| LTE | long-term evolution |
| MAC | medium access control |
| MAC-CE | medium access control - control element |
| MCG | master cell group |
| MIB | master information block |
| NACK | negative acknowledgement |
| NCD-SSB | non cell-defining synchronization signal block |
| NES | network energy saving |
| NR | new radio |
| OFDM | orthogonal frequency-division multiplexing |
| OFDMA | orthogonal frequency-division multiple access |
| PBCH | physical broadcast channel |
| PC5 | interface using the sidelink channel for D2D communication |
| PDCCH | physical downlink control channel |
| PDSCH | physical downlink shared channel |
| PMI | precoding matrix indicator |
| PRACH | physical random access channel |
| PRS | positioning reference signal |
| PSBCH | physical sidelink broadcast channel |
| PSCCH | physical sidelink control channel |
| PSFCH | physical sidelink feedback channel |
| PSS | primary synchronization signal |
| PSSCH | physical sidelink shared channel |
| PUCCH | physical uplink control channel |
| PUSCH | physical uplink shared channel |
| QCL | quasi - colocation |
| RACH | random access channel |
| RAN | radio access networks |
| RE | resource element |
| RRC | radio resource control |
| RS | reference signal |
| RSRP | reference signal received power |
| RSRQ | reference signal received quality |
| SCI | sidelink control information |
| SCG | secondary cell group |
| SIB | system information block |
| SL | sidelink |
| SR | scheduling request |
| SRS | sounding reference signal |
| SSB | synchronization signal block |
| SSS | secondary synchronization signal |
| S-SSB | sidelink synchronization signal block |
| sTTI | short transmission time interval |
| TDD | time division duplex |
| UE | user equipment, e.g., a smartphone or IoT node |
| UL | uplink |
| UMTS | universal mobile telecommunication system |
| V2X | vehicle-to-everything |
| V2V | vehicle-to-vehicle |

1. User equipment, UE, of a wireless communication network,
wherein the user equipment is configured to operate using a baseline configuration,
wherein the user equipment is configured to receive a control signal from a base station of the wireless communication network,
wherein the user equipment is configured to activate or deactivate, in dependence on the received control signal, a further configuration,
wherein the baseline configuration defines a plurality of operating parameters of the user equipment,
wherein the further configuration is configured to, when activated,
add at least one operating parameter to the baseline configuration.

2. User equipment according to claim 1,
wherein the further configuration modifies or replaces the baseline configuration.

3-4. (canceled)

5. User equipment according to claim 1,
wherein the plurality of operating parameters comprise one or more RRC parameters.

6. User equipment according to claim 1,
wherein the user equipment is configured to select the further configuration out of at least two different further configurations in dependence on the received control signal.

7-9. (canceled)

10. User equipment according to claim 6,
wherein the received control signal indicates which further configuration out of the plurality of different further configurations is to be activated or deactivated.

11. User equipment according to claim 6,
wherein each further configuration out of the plurality of different further configurations has an ID associated therewith,
wherein the received control signal comprises an information describing the ID of the further configuration to be activated or deactivated.

12. (canceled)

13. User equipment according to claim 6,
wherein the plurality of further configurations are divided into at least two subsets of further configurations,
wherein the user equipment is configured to select one out of the at least two subsets of further configurations in dependence on a current operation condition of the user equipment or a second control signal received from the base station,
wherein the user equipment is configured to activate or deactivate, in dependence on the current operation condition or on the received control signal, one out of at least two different further configurations of the selected subset of further configurations.

14. (canceled)

15. User equipment according to claim 6,
wherein the received control signal comprises an information indicating which further configuration out of the plurality of different further configurations is to be activated or deactivated,
wherein the information is carried via a higher layer, like an indication in a radio resource control, RRC, layer, or via a media access control, MAC, layer, like an indication in a MAC control element, MAC CE, or via a physical, PHY, layer, like an indication in a downlink control information, DCI

16. User equipment according to claim 1,
wherein the control signal or a further control signal comprises an information describing whether one or more operating parameters defined by the further configuration is active or inactive,
wherein the user equipment is configured to only apply those operating parameters of an active further configuration that are active.

17. (canceled)

18. User equipment according to claim 1,
wherein the further configuration indicates an alternative BLER target for measurements.

19. User equipment according to claim 18,
wherein the BLER target is changed by indicating a CQI table that is different than a CQI table indicated by the baseline configuration.

20. User equipment according to claim 1,
wherein the further configuration define that cell DTX is enabled and that a number of HARQ retransmissions are limited or that HARQ retransmissions are not allowed.

21. User equipment according to claim 1,
wherein the further configuration controls the user equipment to only receive HARQ request on the next cell DTX on time or to retransmit only on the next cell DTX on time.

22-24. (canceled)

25. User equipment according to claim 1,
wherein a further configuration defines a Cell-DTX or Cell-DRX mode based on a bitmap which divides the time into smaller periods and specifies for those subperiods in which subperiods the Cell will stop transmission or reception and which subperiods the cell will resume transmission or reception.

26. User equipment according to claim 1,
wherein the control signal comprises a control information,
wherein the control information signals whether the further configuration is to be activated or deactivated or which further configuration out of a plurality of different further configurations is to be activated or deactivated.

27. User equipment according to claim 26,
wherein the user equipment is configured to receive the control signal comprising the control information periodically.

28-29. (canceled)

30. User equipment according to claim 26,
wherein the further configuration is a network energy saving configuration in which the user equipment operates in a connected-mode discontinuous reception, connected-mode DRX, mode of operation,
wherein the user equipment is configured to receive the control signal comprising the control information only in on-durations of the connected-mode discontinuous reception, connected-mode DRX, mode of operation or with a defined time offset to the on-durations of the connected mode discontinuous reception, connected-mode DRX, mode of operation or only in active durations of the connected-mode discontinuous reception, connected-mode DRX, mode of operation.

31. Base station of a wireless communication network,
wherein the base station is configured to transmit a control signal to a user equipment of the wireless communication network,
wherein the control signal is configured to control the user equipment to activate or deactivate a further configuration,
wherein the baseline configuration defines a plurality of operating parameters of the user equipment,
wherein the further configuration is configured to, when activated,
add at least one operating parameter to the baseline configuration.

32-61. (canceled)

62. Method for operating a user equipment of a wireless communication network, the method comprising:
operating the user equipment using a baseline configuration,
receiving a control signal from a base station of the wireless communication network, activating or deactivating, in dependence on the received control signal, a further configuration,
wherein the baseline configuration defines a plurality of operating parameters of the user equipment,
wherein the further configuration is configured to, when activated,
add at least one operating parameter to the baseline configuration.

63. (canceled)

64. Method for operating a base station of a wireless communication network, the method comprising:
transmitting a control signal to a user equipment of the wireless communication network,
wherein the control signal is configured to control the user equipment to activate or deactivate a further configuration,
wherein the baseline configuration defines a plurality of operating parameters of the user equipment,
wherein the further configuration is configured to, when activated,
add at least one operating parameter to the baseline configuration.

65-66. (canceled)
